(19) United States
(12) Patent Application Publication
(10) Pub. No.: US 2012/0068389 A1
(43) Pub. Date: Mar. 22, 2012

(54) Methods of fabricating polycrystalline ceramic for thermoelectric devices

(76) Inventors: Chan Park, Seoul (KR); Wook Jo, Seoul (KR); Jin-Sang Kim, Seoul (KR); O-Jong Kwon, Seoul (KR)

(21) Appl. No.: 13/064,222

(22) Filed: Mar. 11, 2011

(30) Foreign Application Priority Data
Sep. 17, 2010 (KR) 10-2010-0091868

(51) Int. Cl. C04B 35/645

(52) U.S. Cl. 264/605

(57) ABSTRACT

Provided is a method of fabricating polycrystalline ceramic for thermoelectric devices. The method includes preparing calcined ceramic powders, forming a ceramic sheet by uni-axially pressing the calcined ceramic powders, stacking a plurality of the ceramic sheets in a uni-axial direction, and cofiring the stacked the plurality of the ceramic sheets.

### CROSS-REFERENCE TO RELATED APPLICATIONS

This U.S. non-provisional patent application claims priority under 35 U.S.C. §119 of Korean Patent Applications No. 10-2010-0091868, filed on Sep. 17, 2010, the entire contents of which are hereby incorporated by reference.

### BACKGROUND

The present disclosure herein relates to methods of fabricating polycrystalline ceramic for thermoelectric devices, and more particularly, to methods of fabricating polycrystalline ceramic for thermoelectric devices from a plurality of ceramic sheets.

Thermoelectric effect means a reversible and direct energy conversion between heat and electricity, and is a phenomenon occurred by movement of electrons and holes in a material. The thermoelectric effect is classified into the Peltier effect which is applied to a cooling field using a temperature difference between both ends of a material formed by a current applied from the outside, and the Seebeck effect which is applied to a power generation field using an electromotive force generated from a temperature difference between both ends of a material.

Currently, demand is growing in the fields which are impossible to be resolved by a typical refrigerant gas compression system, for example, an active cooling system coping with a heat generation problem of temperature electronic devices, a precision temperature control system applied to DNA analysis, or the like. Thermoelectric cooling is a vibration-free and low-noise eco-friendly cooling technology which does not make use of a refrigerant gas causing environmental problems, and application areas can be widen to general-purpose cooling fields such as a refrigerator, an air conditioner or the like by developing a high-efficiency thermoelectric cooling material. Also, if a thermoelectric material is applied to heat dissipating portions in an automobile engine, an industrial plant or the like, power generation is possible by the temperature difference between both ends of a material. In spacecrafts for Mars and Saturn, etc., in which the use of a solar energy is impossible, such a thermoelectric power generation system is already in operation.

The biggest factor limiting the applications for the thermoelectric cooling and power generation is low energy conversion efficiency of a material. Performance of a thermoelectric material is commonly referred as a dimensionless figure of merit, and it uses a ZT value defined as the following Mathematical Equation 1.

$$ZT = \frac{{S}^{2} σ}{κ} T \qquad [ Mathematical Equation 1 ]$$

where, Z is a figure of merit, S is a Seebeck coefficient, σ is electrical conductivity, T is an absolute temperature, and κ is thermal conductivity.

However, it showed a trade-off relation in which if either one performance of the electrical conductivity or the Seebeck coefficient increases, the other one decreases such that the ZT value does not exceed 1 by the mid 1990s. Therefore, as shown in the above Mathematical Equation 1, in order to increase the figure of merit (ZT) of a thermoelectric material, researches have been performed to increase the Seebeck coefficient and the electrical conductivity, i.e., a main factor (S²σ), and to decrease the thermal conductivity.

### SUMMARY

The present disclosure provides a method of fabricating polycrystalline ceramic for thermoelectric devices having improved electrical characteristics with low cost and short processing time.

The object of the present invention is not limited to the aforesaid, but other objects not described herein will be clearly understood by those skilled in the art from descriptions below.

Embodiments of the inventive concept provide a method of fabricating polycrystalline ceramic for thermoelectric devices including: preparing calcined ceramic powders; forming a ceramic sheet by uni-axially pressing the calcined ceramic powders; stacking a plurality of the ceramic sheets in a uni-axial direction; and cofiring the stacked the plurality of the ceramic sheets.

In some embodiments, the calcined ceramic powders may have a thin disk-shape. The ceramic powders may include a conductive thermoelectric material.

In other embodiments, the forming of the ceramic sheet may include the providing of the calcined ceramic powders to a supporting part of a pressing apparatus, and the pressing of the calcined ceramic powders with a pressing part of the pressing apparatus. The supporting part and the pressing part may have a rimless flat surface. The pressing part may press the calcined ceramic powders with a pressure range of about 30-100 MPa.

In still other embodiments, the cofiring of the stacked the plurality of the ceramic sheets may include performing at least one selected from sintering, spark plasma sintering (SPS), or hot pressing.

In even other embodiments of the inventive concept, a method of fabricating polycrystalline ceramic for thermoelectric devices may further include performing a reoxidation process after the cofiring of the stacked the plurality of the ceramic sheets.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIGS. 1 through 5 are cross-sectional views and a perspective view illustrating a method of fabricating polycrystalline ceramic for thermoelectric devices according to embodiments of the inventive concept.

### DETAILED DESCRIPTION OF THE EMBODIMENTS

Preferred embodiments of the present invention will be described below in more detail with reference to the accompanying drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. Like reference numerals refer to like elements throughout.

In the following description, the technical terms are used only for explaining specific embodiments while not limiting the present invention. In the inventive concept, the terms of a singular form may include plural forms unless otherwise specified. The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. Additionally, in the specification, it will be understood that when an element such as a layer, film, region, or substrate is referred to as being “on” another element, it can be directly on the other element or intervening elements may also be present.

The embodiments in the detailed description will be described with sectional views and/or plan views as ideal exemplary views of the inventive concept. In the drawings, the dimensions of layers and regions are exaggerated for clarity of illustration. Accordingly, shapes of the exemplary views may be modified according to manufacturing techniques and/or allowable errors. The embodiments of the present invention are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a device region. Thus, this should not be construed as limited to the scope of the inventive concept.

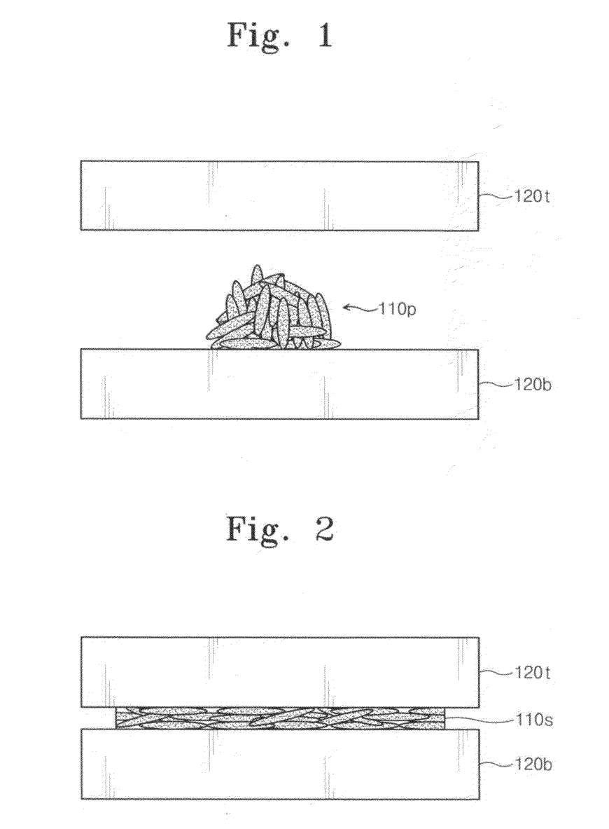

FIGS. 1 through 5 are cross-sectional views and a perspective view illustrating a method of fabricating polycrystalline ceramic for thermoelectric devices according to embodiments of the inventive concept. For more detailed description, a method of fabricating polycrystalline ceramic using a thermoelectric material of Ca₃Co₄O₉ will be described as an example.

Referring to FIG. 1, calcined ceramic powders 110p are provided to a pressing apparatus. The pressing apparatus may include a supporting part 120b and a pressing part 120t. In order to enable to perform a uni-axial pressing, the supporting part 120b and the pressing part 120t of the pressing apparatus may have a rimless flat surface.

The calcined ceramic powders 110p are provided on a surface of the supporting part 120b of the pressing apparatus. The calcined ceramic powders 110p may have a thin disk-shape. The ceramic powders may include a conductive thermoelectric material. The conductive thermoelectric material may include NaCo₂O₄, Ca₃Co₄O₉, Sr₃Co₄O₉, etc.

The calcined ceramic powders 110p may be prepared by mixing CaCo₃ and Co₃O₄ weighed according to a stoichiometric formula while being ground in ethanol, drying the mixed powders, and then calcining the resultant powders at about 880° C. in an oxygen atmosphere.

A weight of calcined Ca₃Co₄O₉ powders, which are provided on the surface of the supporting part 120b of the pressing apparatus, is about 0.07 g.

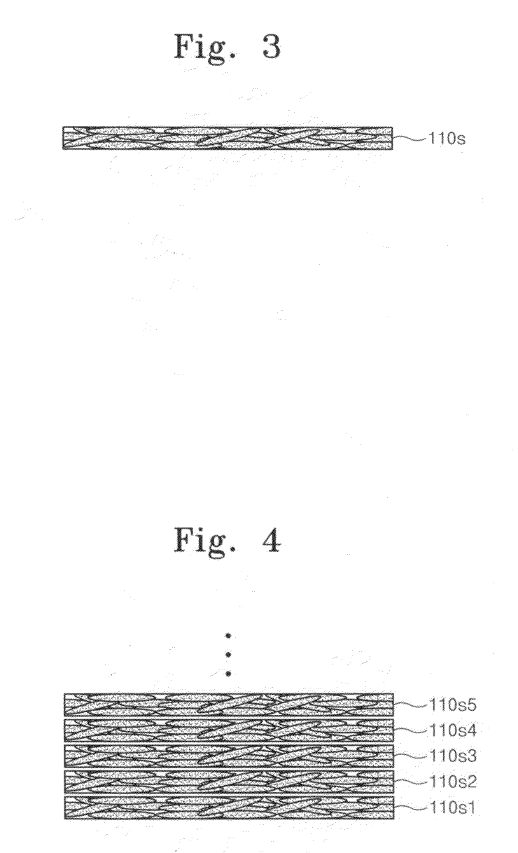

Referring to FIGS. 2 and 3, the calcined ceramic powders 110p, which are provided on the surface of the supporting part 120b of the pressing apparatus, are pressed by the pressing part 120t of the pressing apparatus. The pressing part 120t of the pressing apparatus may press the calcined ceramic powders 110p with a pressure range of about 30-100 MPa.

Since the supporting part 120b and the pressing part 120t of the pressing apparatus have the rimless flat surface, the calcined ceramic powders 110p may be uni-axially pressed to form a ceramic sheet 110s. The ceramic sheet 110s may be cut to have a constant diameter.

A Ca₃Co₄O₉ sheet, which is formed by uni-axially pressing the calcined Ca₃Co₄O₉ powders with a pressure of about 40 MPa by the pressing part 120t of the pressing apparatus, has a thickness of about 0.5 mm or less. The Ca₃Co₄O₉ sheet is cut into a circular disk having a diameter of about 10 mm.

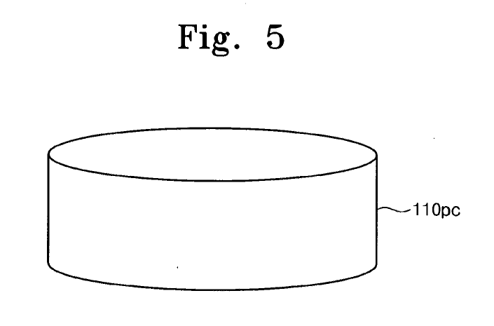

Referring to FIGS. 4 and 5, a plurality of ceramic sheets 110s1, 110s2, 110s3, 110s4, 110s5, . . . are stacked in a uni-axial direction, and then polycrystalline ceramic 110pc is formed by cofiring the stacked the plurality of the ceramic sheets 110s1, 110s2, 110s3, 110s4, 110s5, . . . .

The cofiring of the stacked the plurality of the ceramic sheets 110s1, 110s2, 110s3, 110s4, 110s5, . . . may include the performing of at least one selected from sintering, spark plasma sintering (SPS), or hot pressing.

A reoxidation process may be performed on the polycrystalline ceramic 110pc that is formed by cofiring the the stacked the plurality of the ceramic sheets 110s1, 110s2, 110s3, 110s4, 110s5, . . . . The reoxidation process may be performed for the purpose of replenishing an oxide constituting the polycrystalline ceramic 110pc with oxygen.

A plurality of Ca₃Co₄O₉ sheets are stacked, and then polycrystalline Ca₃Co₄O₉ is formed by SPS in which the stacked Ca₃Co₄O₉ sheets are cofired while being pressed with a pressure of about 40 MPa at about 900° C. The polycrystalline Ca₃Co₄O₉ has a cylindrical shape with a thickness of about 8 mm.

The polycrystalline Ca₃Co₄O₉, which was manufactured by a method according to an embodiment of the inventive concept, showed a Seebeck coefficient of about 177 μV/K and electrical resistivity of about 5.9 mΩ·cm at a temperature of about 973 K. That is, it can be understood that the polycrystalline Ca₃Co₄O₉, which was manufactured by a method according to an embodiment of the inventive concept, have a thermoelectric main factor (S²σ) of about 5.2×10⁻⁴ W/mK² at a temperature of about 973 K. The polycrystalline Ca₃Co₄O₉, which was manufactured by a method according to an embodiment of the inventive concept, showed electrical characteristics improved by about 20% more than polycrystalline Ca₃Co₄O₉ manufactured by typical cold isostatic pressing (CIP) and sintering. This is because that the polycrystalline Ca₃Co₄O₉, which is manufactured by a method according to an embodiment of the inventive concept, has a more improved grain boundary direction than the polycrystalline Ca₃Co₄O₉ manufactured by typical CIP and sintering.

The polycrystalline Ca₃Co₄O₉, which is manufactured by a method according to an embodiment of the inventive concept, is formed by stacking and cofiring the ceramic sheets formed by uni-axially pressing, thereby enabling to have an improved grain boundary direction. Therefore, polycrystalline ceramic for thermoelectric devices having improved electrical characteristics can be provided with low cost and short processing time.

As described above, according to the exemplary embodiments of the inventive concept, since polycrystalline ceramic is fabricated such that ceramic sheets formed by uni-axially pressing are stacked and cofired, the polycrystalline ceramic have an improved grain boundary direction. Therefore the polycrystalline ceramic for thermoelectric devices having improved electrical characteristics can be provided with low cost and short processing time.

While this inventive concept has been particularly shown and described with reference to preferred embodiments thereof, it will be understood by those skilled in the art that various changes in form and details may be made therein without departing from the spirit and scope of the inventive concept as defined by the appended claims. The preferred embodiments should be considered in descriptive sense only and not for purposes of limitation. Therefore, the scope of the inventive concept is defined not by the detailed description of the inventive concept but by the appended claims, and all differences within the scope will be construed as being included in the present inventive concept.

What is claimed is:

1. A method of fabricating polycrystalline ceramic for thermoelectric devices, the method comprising:
preparing calcined ceramic powders;
forming a ceramic sheet by uni-axially pressing the calcined ceramic powders;
stacking a plurality of the ceramic sheets in a uni-axial direction; and
cofiring the stacked the plurality of the ceramic sheets.

2. The method of claim 1, wherein the calcined ceramic powders have a thin disk-shape.

3. The method of claim 2, wherein the ceramic powders comprise a conductive thermoelectric material.

4. The method of claim 1, wherein the forming of the ceramic sheet comprises:
providing the calcined ceramic powders to a supporting part of a pressing apparatus; and
pressing the calcined ceramic powders with a pressing part of the pressing apparatus,
wherein the supporting part and the pressing part have a rimless flat surface.

5. The method of claim 4, wherein the pressing part presses the calcined ceramic powders with a pressure range of about 30-100 MPa.

6. The method of claim 1, wherein the cofiring of the stacked the plurality of the ceramic sheets comprises performing at least one selected from sintering, spark plasma sintering (SPS), or hot pressing.

7. The method of claim 1, further comprising:
after the cofiring of the stacked the plurality of the ceramic sheets, performing a reoxidation process.
